(19) United States
(12) Patent Application Publication
(10) Pub. No.: US 2026/0011904 A1
(43) Pub. Date: Jan. 8, 2026

(54) ADDITIVE MANUFACTURED WAVEGUIDE

(71) Applicant: SAMTEC, INC., New Albany, IN (US)

(72) Inventors: John L. NIGHTINGALE, New Albany, IN (US); Joseph Bryan SEGER, Jr., New Albany, IN (US)

(21) Appl. No.: 18/992,332

(22) PCT Filed: Jul. 7, 2023
(86) PCT No.: PCT/US2023/069818

§ 371 Date: Jan. 8, 2025

Related U.S. Application Data
(60) Provisional application No. 63/359,348, filed on Jul. 8, 2022.

(51) Int. Cl. H01P 11/00; B33Y 10/00; B33Y 80/00

(52) U.S. Cl. CPC H01P 11/006; B33Y 10/00; B33Y 80/00

(57) ABSTRACT

A cable can include a first end and a second end. The cable can be adapted to transmit an electrical signal or light from the first end to the second end. The cable can be a non-extruded dielectric. The cable can be a waveguide. The cable can be manufactured by three-dimensional printing. The cable can have any desired length. The cable can be manufactured by sequentially printing any number of segments.

### CROSS-REFERENCE TO RELATED APPLICATIONS

This application claims the benefit of U.S. Provisional Application Ser. No. 63/359,348 filed Jul. 8, 2022, the contents of which is hereby incorporated by reference as if set forth in its entirety herein.

### TECHNICAL FIELD

The present disclosure relates generally to dielectric materials, and more specifically to dielectric materials created by an additive manufacturing process.

### BACKGROUND

A waveguide can refer to a structure that conveys electromagnetic waves between its endpoints. Some waveguides include a hollow structure to carry electromagnetic waves. A dielectric waveguide can include a solid dielectric core rather than a hollow structure. Dielectric waveguides can be manufactured from a dielectric foam. However, dielectric foams can present issues when producing waveguides having a significant length. Therefore, an improved method of manufacturing a waveguide is desired.

U.S. Pat. No. 11,283,208, herein incorporated by reference in its entirety, describes additive manufacturing. U.S. Pat. No. 11,196,210, herein incorporated by reference in its entirety, describes additive manufacturing. U.S. Pat. No. 10,449,713, herein incorporated by reference in its entirety, describes additive manufacturing. U.S. Pat. No. 6,146,199, herein incorporated by reference in its entirety, describes continuous plastic strips.

Shaghik Atakaramians, Shahraam Afshar V., Tanya M. Monro and Derek Abbott, “Terahertz Dielectric Waveguides”, Advances in Optics and Photonics, Vol. 5, Issue 2, pp. 169-215 (2013), herein incorporated by reference in its entirety, discloses waveguide cross-sections.

U.S. Pat. No. 11,031,666, hereby incorporated by reference in its entirety, describes an elongate waveguide core that includes at least one space arranged lengthwise along the waveguide core.

United State U.S. Pat. No. 5,830,012, hereby incorporated by reference in its entirety, describes continuous manufacturing of a plastic strip.

### SUMMARY

In general, articles and methods of making a non-extruded, continuous dielectric, such as a non-extruded, continuous dielectric waveguide, are disclosed. For example, a continuous waveguide, a continuous dielectric article and/or a continuous cable dielectric can be made by 3-D printing. The dielectric can be solid, can be hollow, can define a lattice structure, can be partially hollow with internal mechanical supports, can contain no monolithic internal supports, can contain no monolithic sacrificial internal supports that run a partial or entire longitudinal length of the dielectric material, can contain no monolithic external supports, and/or can contain no monolithic sacrificial external supports that run a partial or entire longitudinal length of the dielectric material.

In one embodiment, a dielectric waveguide having a plurality of first segments having a first effective dielectric constant and a first cross-sectional shape is described. The dielectric waveguide further includes a plurality of second segments having a second effective dielectric constant and a second cross-sectional shape. The plurality of first segments and the plurality of second segments are arrange along a longitudinal direction to form the dielectric waveguide and at least one of the first effective dielectric constant is different than the second effective dielectric constant or the first cross-sectional shape is different than the second cross-sectional shape.

In another embodiment, a dielectric waveguide comprising a plurality of segments having a thickness along a longitudinal direction and arranged along the longitudinal direction to form the dielectric waveguide are described. The thickness of each segment in the plurality of segments may be constant or the thickness may be varied in a random or psuedo-random manner.

A method of fabricating a dielectric waveguide can include a) curing a polymer in a reservoir from a first state to a second state, b) incrementally advancing the cured polymer approximately an incremental distance away from the reservoir, and repeating steps a) to b). The method can include introducing polymer into the reservoir.

The incremental distance can be within a range of approximately 1 micron to approximately 75 microns. Curing the polymer from the first state to the second state can include curing the polymer from a liquid state to a solid state. The reservoir can have a height in a longitudinal direction and providing the reservoir of polymer can include providing the polymer at a depth in the longitudinal direction of approximately 1 micron to approximately 75 microns.

The advancing step can be along the longitudinal direction, such that the incremental distance can be measured in the longitudinal direction. The reservoir includes a base with a first side and a second side spaced from the first side along a transverse direction, a first edge and a second edge spaced from the first edge along a lateral direction transverse to the transverse direction, and a sidewall extending from the base and having a height in the longitudinal direction, the longitudinal direction transverse to each of the lateral direction and the transverse direction. The polymer can be a photopolymer resin. The curing step can include exposing the polymer to a light source. The light source can be directed at the polymer in the reservoir. The light source can be an ultraviolet light source. The curing step can include curing at least half the depth of the polymer. The curing step can include curing approximately 1 micron to approximately 75 microns of the polymer to form a cured polymer. The curing step can include curing the polymer while the polymer can be in contact with a non-stick sheet. The reservoir can include a non-stick sheet and the curing step includes curing the polymer while the polymer can be in contact with the non-stick sheet. The curing step can cause the cured polymer to adhere to the non-stick sheet. The advancing step can cause the cured polymer to detach from the non-stick sheet.

The curing step can cause the cured polymer to adhere to the non-stick sheet and the advancing step causes the cured polymer to detach from the non-stick sheet. The non-stick sheet comprises polytetrafluoroethylene. The incremental distance can be within a range of approximately 1 micron to approximately 50 microns. The polymer can comprise an electrically conductive material. The curing step can include curing the polymer with a printer. The curing step can include curing the polymer with a three-dimensional printer. The printer can include an actuator assembly and the method can include engaging the cured polymer with the actuator assembly. The advancing step can include incrementally advancing the cured polymer by moving the actuator assembly. The actuator assembly can include a first engagement assembly and a second engagement assembly, wherein the method can include engaging the cured polymer with the first and second engagement assemblies.

At least one of the first and second engagement assemblies can be engaged with the cured polymer during the curing step. Each of the first and second engagement assemblies can be engaged with the cured polymer during the curing step. Engaging the cured polymer with the first and the second engagement assemblies can include moving each of the first and second engagement assemblies relative to the cured polymer. Moving the first and second engagement assemblies relative to the cured polymer can include moving the first and second engagement assemblies in a lateral direction transverse to the longitudinal direction. The advancing step can include sequentially disengaging the first and second engagement assemblies from the cured polymer. The advancing step can include sequentially engaging the cured polymer with the first and second engagement assemblies.

The advancing step can include disengaging the first engagement assembly from the cured polymer while the second engagement assembly is engaged with the cured polymer. The advancing step can include moving the first engagement assembly relative to the second engagement assembly. Moving the first engagement assembly relative to the second engagement assembly can include moving the first engagement assemblies in the longitudinal direction relative to the second engagement assembly. Moving the first engagement assembly in the longitudinal direction can include moving the first engagement assembly toward the reservoir. The advancing step can include reengaging the cured polymer with the first engagement assembly after the first engagement assembly moves toward the reservoir. The advancing step can include disengaging the second engagement assembly from the cured polymer after reengaging the cured polymer with the first engagement assembly. The advancing step can include moving the first engagement assembly relative to the second engagement assembly after disengaging the second engagement assembly from the cured polymer.

Moving the first engagement assembly relative to the second engagement assembly can include moving the first engagement assembly in the longitudinal direction. Moving the first engagement assembly relative to the second engagement assembly includes moving the cured polymer relative to the second engagement assembly. Moving the first engagement assembly relative to the second engagement assembly can include moving the first engagement assembly away from the reservoir. The advancing step can include reengaging the cured polymer with the second engagement assembly after the first engagement assembly moves relative to the second actuator. Reengaging the cured polymer with the second engagement assembly can include reengaging the cured polymer with the second engagement assembly while the first engagement assembly can be engaged with the cured polymer.

The method can include engaging a sacrificial element with the first engagement assembly and the second engagement assembly. The method can include moving the sacrificial element toward the reservoir such that at least a portion of the sacrificial element can be within the reservoir. The curing step can include curing the polymer such that the cured polymer is coupled to the sacrificial element.

The cured polymer can be one segment of cured polymer having a segment height along a longitudinal axis, wherein advancing the cured polymer can include advancing the cured polymer along the longitudinal axis by a distance less than the segment height. Advancing the cured polymer can include advancing the cured polymer by at least half the segment height.

The method can include engaging the polymer with a starter filament prior to the curing step. The method can include a step of washing the cured polymer. The washing step can include removing uncured polymer from the continuous article. The method can include a step of drying the cured polymer. The method can include a step of further curing the cured polymer. The further curing step can include exposing the cured polymer to a light source. The light source can be an ultraviolet light source. The method can include a step of spooling the cured polymer. The cured polymer can define a lattice structure. The cured polymer can be not extruded. The continuous article can be adapted to allow an electrical signal to pass from a first end of the continuous article to a second end of the continuous article. The curing step can include curing the polymer without a monolithic or monolithical support member or a sacrificial support member.

A method of fabricating a dielectric waveguide can include steps of a) transitioning a printable or sinterable material in a reservoir from a first state to a second state, b) incrementally advancing the transitioned printable or sinterable material an incremental distance away from the reservoir, and repeating steps a) to b).

The incremental distance can be within a range of approximately 1 micron to approximately 75 microns. The method can include introducing printable or sinterable material into the reservoir. Transitioning the printable or sinterable material from the first state to the second state can include exposing the material to an elevated temperature such that the printable or sinterable material transitions from the first state to the second state. The elevated temperature can be at least 100 degrees Celsius. Transitioning the printable or sinterable material from the first state to the second state can include transitioning the printable or sinterable material from a powder to a solid. The incrementally advancing step can be along the longitudinal direction, such that the incremental distance can be measured the longitudinal direction.

A cable can include a non-extruded dielectric. The non-extruded dielectric can be not injection molded. The non-extruded dielectric can be a waveguide. The non-extruded dielectric has a linear length of at least three meters. The non-extruded dielectric can be elongate along a central axis and the length can be at least three meters along the central axis. The non-extruded dielectric defines a non-homogeneous cross-sectional density. The non-extruded dielectric can define a non-homogeneous cross-sectional pattern. The non-extruded dielectric can define a non-homogenous cross-sectional shape. The cross-section can be taken along a plane perpendicular to the central axis. The non-extruded dielectric can define a lattice.

The non-extruded dielectric can comprise a polymer. The non-extruded dielectric can comprise air, which can be defined by air voids. The non-extruded dielectric has multiple, sequential, stacked segments. Each of the segments can have a thickness of at least approximately 1 micron to approximately 10 microns; of at least approximately 11 microns to approximately 20 microns; approximately 21 microns to approximately 30 microns; of at least 31 microns to approximately 40 microns; at least approximately 41 microns to approximately 50 microns; at least approximately 51 microns to at least approximately 60 microns; at least approximately 61 microns to approximately 70 microns; or at least approximately 71 microns to approximately 80 microns. The cable can include no seams between the layers. The non-extruded dielectric can be printed by a printer. The cable can be hollow. The cable can be solid. The cable can be partially hollow.

In a further embodiment, an article made from a non-extruded material can be devoid of a monolithical support member or a sacrificial support member that can be removed post-manufacturing.

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 is a perspective view of an article in accordance with one embodiment of the present disclosure;

FIG. 2 is a perspective view of a lattice structure in accordance with one embodiment of the present disclosure;

FIG. 3 is a perspective view of the article of FIG. 1 and a three-dimensional printer including an actuator assembly in accordance with one embodiment of the present disclosure;

FIG. 4 is an enlarged perspective view of a portion of the three-dimensional printer, the actuator assembly, and the article of FIG. 3;

FIGS. 5A-5F are perspective views illustrating steps of a process to manufacture the article of FIG. 1 as performed by the three-dimensional printer and the actuator assembly of FIG. 3;

FIG. 6 is a perspective view of the three-dimensional printer of FIG. 3 and a wash station, a dry station, a curing station, and a spool;

FIG. 7 is a flow chart of a method of manufacturing the continuous article of FIG. 1;

FIG. 8 is a cross-section along a longitudinal direction of a dielectric waveguide showing identical segments in accordance with one embodiment of the present disclosure;

FIG. 9 is a cross-section along a longitudinal direction of a dielectric waveguide showing segments of different thickness in accordance with one embodiment of the present disclosure;

FIG. 10 is a simplified cross-section along a longitudinal direction of a dielectric waveguide showing segments composed of equal thickness but different materials in accordance with one embodiment of the present disclosure; and

FIG. 11 is a simplified cross-section along a longitudinal direction of a dielectric waveguide showing interspersed first and second segments in accordance with one embodiment of the present disclosure.

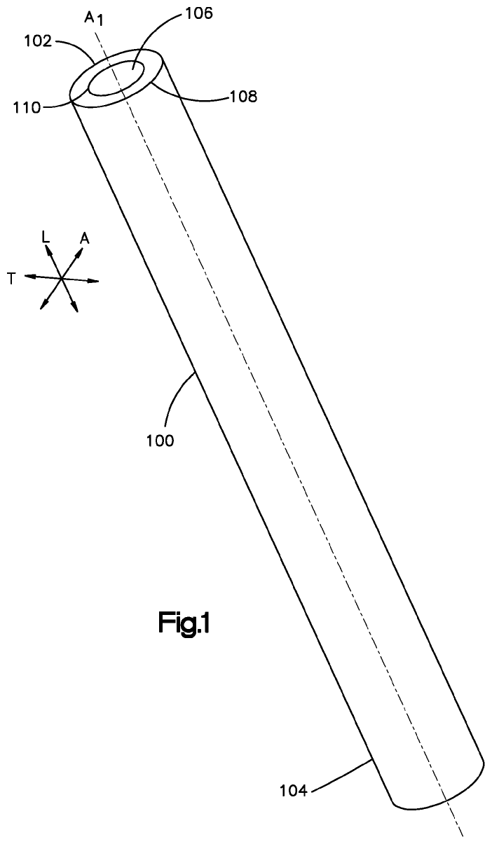

Aspects of the disclosure will now be described in detail with reference to the drawings, wherein like reference numbers refer to like elements throughout, unless specified otherwise.

### DETAILED DESCRIPTION

The present disclosure can be understood more readily by reference to the following detailed description taken in connection with the accompanying figures and examples, which form a part of this disclosure. It is to be understood that this disclosure is not limited to the specific devices, methods, applications, conditions, or parameters described and/or shown herein, and that the terminology used herein is for the purpose of describing particular embodiments by way of example only and is not intended to be limiting of the scope of the present disclosure. Further, reference to a plurality as used in the specification including the appended claims includes the singular “a,” “an,” “one,” and “the,” and further includes “at least one.” Further still, reference to a particular numerical value in the specification including the appended claims includes at least that particular value, unless the context clearly dictates otherwise.

The term “plurality,” as used herein, means more than one. When a range of values is expressed, the range extends from the one particular value to the other particular value. Similarly, when values are expressed as approximations, by use of the antecedent “about,” it will be understood that the particular value forms another example. All ranges are inclusive and combinable.

The term “substantially,” “approximately,” and derivatives thereof, and words of similar import, when used to described sizes, shapes, spatial relationships, distances, directions, and other similar parameters includes the stated parameter in addition to a range up to 10% more and up to 10% less than the stated parameter, including up to 5% more and up to 5% less, including up to 3% more and up to 3% less, including up to 1% more and up to 1% less. If terms such as “equal,” “perpendicular”, or a numerical value associated with a given dimension are used to compare or describe elements of the invention, the terms should be interpreted as referring to within manufacturing tolerances.

Disclosed herein is an article of manufacture, generally designated 100, that can be any desired length. The article 100 can be a dielectric material. The article 100 can be a cable. The article 100 can be a cable dielectric. The article 100 can be a dielectric cable waveguide. The article 100 can be configured to transmit a data signal. In some examples, the signal is an optical signal. In other examples, the signal is an electrical signal. The article 100 can define a dielectric cable waveguide that is configured to propagate radio frequency (RF) electrical signals from a first electrical component to a second electrical component. The article 100 can be adapted to allow light to pass through the article. The article 100 can be adapted to allow electromagnetic radiation of any desired frequency range to pass through the article. The article 100 can include a first end 102 and a second end 104. The second end 104 can be spaced from the first end 102 along a central axis A₁. The first and second ends 102, 104 can be spaced from each other in a longitudinal direction L. The article 100 can be elongate along the central axis A₁. The article 100 can have any desired length between the first end 102 and the second end 104. The length can be at least 1 meter, at least 3 meters, at least 5 meters, or at least 10 meters.

The article 100 can include an opening 106 that extends from the first end 102 toward the second end 104. The opening 106 can extend the length of the article 100 between the first and second ends 102, 104. The opening 106 can allow electromagnetic radiation to pass through the article 100. The opening 106 can be adapted to receive a conductive element. The conductive element can be an electrically conductive element. The electrically conductive element can include a wire. The electrically conductive element can be metal. The article 100 can include an outer wall 108. The article 100 can include an inner wall 110 spaced from the outer wall 108 along a lateral direction A. The lateral direction A can be perpendicular to the longitudinal direction L. The inner wall 110 can define the opening 106. In some embodiments, the outer wall 108 is separated from the inner wall 110 by one or more voids such that the article 100 is hollow or at least partially hollow. The outer wall 108 can be separated from the inner wall 110 by one or more spaces with air in the spaces. In other embodiments, the inner wall 110 and outer wall 108 are inner and outer surfaces, respectively, of a solid body. In some embodiments, the article 100 does not include an inner wall 110 such that the article 100 is a solid structure.

In some examples, the article 100 can have a circular cross-sectional shape. In other examples, the article 100 can have an acircular cross-sectional shape. The article 100 can have a non-homogenous cross-sectional shape. The cross-section can be taken in a plane perpendicular to the longitudinal axis L. In some embodiments, the cross-sectional shape at a first point along the central axis A₁ can be different than the cross-sectional shape at a second point along the central axis A₁ spaced from the first point.

In some embodiments, the article 100 can have a homogenous cross-sectional density. In other embodiments, the article 100 can include a non-homogeneous cross-sectional density. In some embodiments, the cross-sectional density at a first point along the central axis A₁ can be different than the cross-sectional density at a second point along the central axis A₁ spaced from the first point. In some embodiments, the density of the article 100 at a first point in the cross-sectional plane can be different than the density of the article 100 at a second point in the cross-sectional plane different from the first point.

In some embodiments, the article 100 can include a homogenous cross-sectional pattern. In other embodiments, the article 100 can include a non-homogenous cross-sectional pattern. In some embodiments, the cross-sectional pattern at a first point along the central axis A₁ can be different than the cross-sectional pattern at a second point along the central axis A₁ spaced from the first point. In some embodiments, the pattern of the article 100 at a first point in the cross-sectional plane can be different than the pattern of the article 100 at a second point in the cross-sectional plane different from the first point.

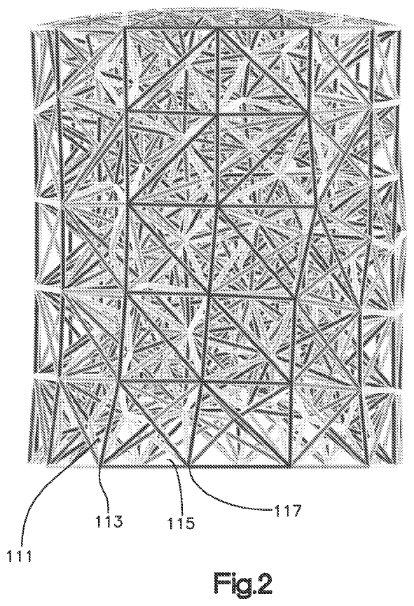

The article 100 can define a lattice. The article 100 can define a three-dimensional (“3-D”) lattice structure. Referring to FIG. 2, a 3-D lattice structure can include a plurality of struts 111 connected at respective nodes 113. The struts 111 can be connected at respective nodes 113 that define the 3-D lattice structure. The 3-D lattice structure can include pores 115 defined by the struts. The struts and nodes can define a unit cell 117. The lattice structure can include a plurality of unit cells 117. The unit cells can be homogenous. In other embodiments, at least one unit cell of the plurality of unit cells can have a different shape than another unit cell of the plurality of unit cells. The struts 111 can each have a length as measured between the nodes 113. The length and thickness of the struts 111 can influence the size of the pores 115. For example, a unit cell with shorter, thicker struts will result in smaller pores than a unit cell with longer, thinner struts. The struts 111 can define a uniform porosity throughout the 3-D lattice structure.

Existing dielectric elements can be manufactured with a monolithic support member or a sacrificial support member that must be removed after manufacture. However, this requires an additional step in a process to manufacture the dielectric elements. At least one embodiment of the article 100 can be made from a non-extruded material without a monolithic support member or a sacrificial support member that is removed post-manufacturing.

The article 100 can be a non-extruded dielectric. The article can be a non-extruded dielectric that is not injection molded. The article 100 can be manufactured from a polymer. The article 100 can be manufactured from a resin. The article 100 can be manufactured from a photopolymer. The article 100 can be manufactured from a metal. The article 100 can be manufactured from a powder. The article 100 can be manufactured from a metal in powder form. The article 100 can be manufactured by transitioning a printable or sinterable material from a first state to a second state. The first state can be a powder form. The second state can be a solid.

The article 100 can be manufactured by transitioning a compound from a first state to a second state. The article 100 can be manufactured by continuously transitioning the compound from the first state to the second state to provide an article having any desired length. The first state can be a liquid or powder state. The second state can be a solid state. The compound can be a polymer. The compound can be a resin. The compound can be a photopolymer resin. The compound can be an electrically conductive material.

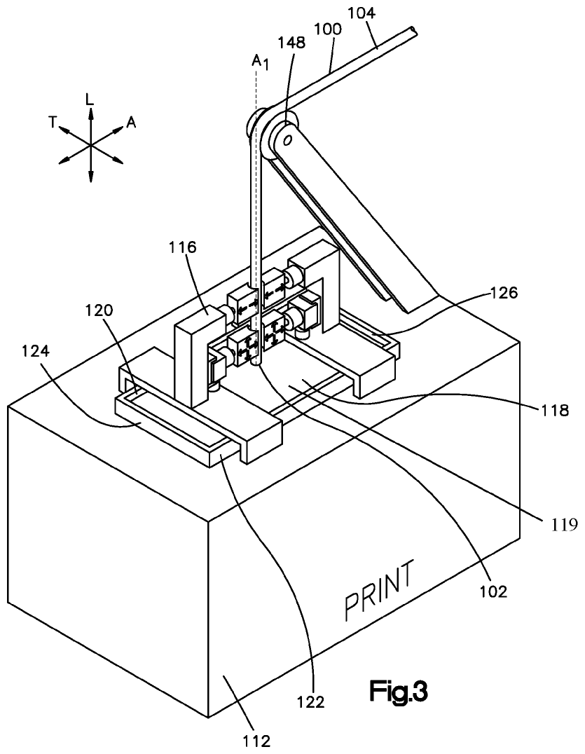

Referring to FIG. 3, a printer 112 can print the article 100. The printer 112 can be a 3-D printer. One example of a 3-D printer is an Elegoo Mars 3 (LCD) printer manufactured by Elegoo Inc. of Shenzhen, Guangdong, China. Another example of a 3-D printer is a Stratasys Origin 1 (DLP) resin printer manufactured by Stratasys, LTD of Eden Prairie, Minnesota. However, the feed mechanisms of the contemplated printers can be replaced by an actuator assembly 116 as described herein. The printer 112 can include a controller configured to send one or more signals to components of the printer to 3-D print an object.

Referring to FIG. 3, the printer 112 can include a reservoir 118 adapted to receive the compound. The printer 112 can include a pixelated array of ultraviolet light to cure the compound in the reservoir 118. The controller can send a signal for the light to cure the compound. The light can cure the compound in response to receiving a curing signal. Curing can transition the compound from a first state to a second state. A cross-sectional shape of the article 100 may be defined by the printer 112, which selectively transitions a portion of the compound in the reservoir 118 from the first state to the second state to form the article 100.

The reservoir 118 can include a first sidewall 120 and a second sidewall 122 spaced from the first sidewall 120 in the transverse direction T. The transverse direction T can be perpendicular to each of the longitudinal and lateral directions L, A. The reservoir 118 can include a first edge wall 124 and a second edge wall 126 spaced from the first edge wall 124 in the lateral direction A. The first and second sidewalls 120, 122 and the first and second edge walls 124, 126 can each extend from a base 119 in the longitudinal direction L. The base 119 can be a planar surface that extends in a plane including the lateral and transverse directions A, T. The reservoir can have a height in the longitudinal direction L. The height can be approximately 1-75 microns. The reservoir 118 can include a non-stick sheet. The non-stick sheet can be polytetrafluoroethylene (a Teflon™ fluoropolymer). The non-stick sheet can be coupled to the base 119. The non-stick sheet can be positioned between the base 119 and the compound to reduce adhesion between the compound and base 119 to prevent breakage of the article 100 as the article 100 is moved away from the reservoir 118. In some embodiments the printer 112 cures the compound from beneath the reservoir such that the compound is cured while it is in contact with the non-stick sheet. The non-stick sheet can be a sheet that is inserted into the reservoir 118 onto the base 119. In other examples, the non-stick sheet can be a coating that is applied to the base 119. The non-stick sheet can cover the entire surface of the base 119. Alternatively, the non-stick sheet can cover less than the entire surface of the base 119.

The printer 112 can be adapted to create the article 100 by sequentially printing multiple segments. The article 100 can include multiple, sequential, stacked segments. The article 100 can include a plurality of segments coupled to each other. The segments can be positioned adjacent each other along the central axis A₁. The segments can be coupled to each other. The segments can be coupled to each other such that there are no seams between the segments. The segments can contact each other to form an uninterrupted outer wall 108 of the article 100. The segments can be coupled to each other such that the article 100 is a continuous article. Each segment can have a height along the central axis A₁ of approximately 1 micron to approximately 10 microns; of at least approximately 11 microns to approximately 20 microns; of at least approximately 21 microns to approximately 30 microns; of at least 31 microns to approximately 40 microns; of at least approximately 41 microns to approximately 50 microns; of at least approximately 51 microns to approximately 60 microns; of at least approximately 61 microns to approximately 70 microns; or of at least approximately 71 microns to approximately 80 microns.

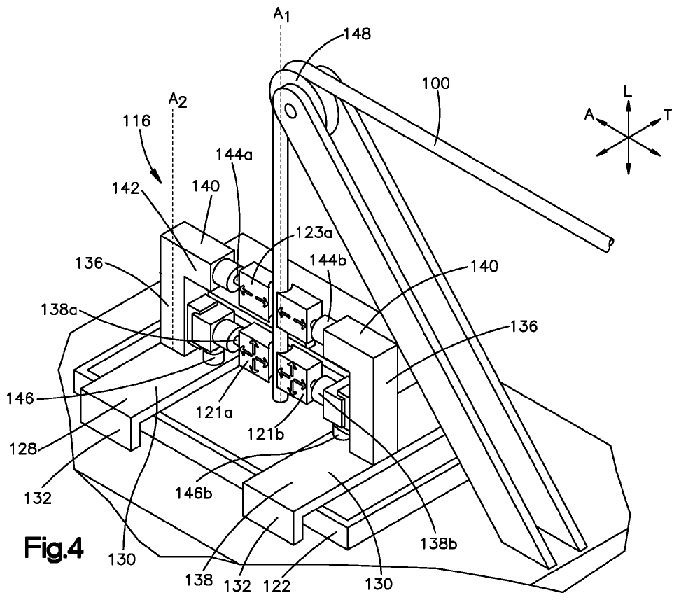

The printer 112 can include an actuator assembly 116 adapted to move the article 100 during printing. Referring to FIG. 4, the actuator assembly 116 can include a first engagement assembly. The first engagement assembly can include first and second engagement members 121a, 121b that engage and move the article 100. The first and second engagement members 121a, 121b can move the article 100 in the longitudinal direction L. The actuator assembly 116 can include first and second actuators 138a, 138b, configured to move the first and second engagement members 121a, 121b. The controller can send a signal to at least one of the first and second actuators 138a, 138b. At least one of the first and second actuators 138a, 138 can move at least one of the first and second engagement members 121a, 121b in response to receiving an actuation signal. The first and second actuators 138a, 138b can each be directly or indirectly coupled to a span 128.

The span 128 can define a generally planar surface to support a support arm 136. The span 128 can be coupled to the reservoir 118. In some examples, the span 128 is fixed relative to the reservoir 118. In other examples, the span 128 is moveable in the transverse direction T relative to the reservoir 118. The span 128 can be coupled to one or more of the first sidewall 120 and second sidewall 122. The span 128 can be coupled to each of the first sidewall 120 and the second sidewall 122. The span 128 can extend from the first sidewall 120 to the second sidewall 122. The span 128 can have a length that is greater than a distance between the first and second sidewalls 120, 122. The span 128 can extend from a first side of the first sidewall 120 to a second side of the first sidewall 120. The span 128 can include a first portion 130 that is elongate along the transverse direction T. The span 128 can include a second portion 132 transverse to the first portion 130. The second portion 132 can be perpendicular to the first portion 130. The second portion 132 can engage the second sidewall 122 so as to prevent movement of the span 128 in the lateral direction A.

The support arm 136 can be coupled to the span 128. The support arm 136 can be coupled to the first portion 130 of the span 128. The support arm 136 can be fixed to the span 128. The support arm 136 and the span 128 can be a monolithic element. The support arm 136 can be elongate along a central axis A₂. The central axis A₂ can be parallel to the central axis A₁ of the article 100. A guide feature 125 can be coupled to the support arm 136. The guide feature 125 can be configured to engage an actuator block 127 as explained below. The actuator assembly 116 can include a plurality of spans 128 and support arms 136 such that the first and second actuators 138a, 138b are each supported by respective ones of the support arms 136.

An extension 142 can be coupled to the support arm 136. The extension 142 can extend away from the support arm 136. The support arm 136 and extension 142 can be a monolithic element. The extension 142 can be generally perpendicular to the support arm 136. The extension 142 can be elongate along a central axis that is perpendicular to the central axis of the support arm 136. The actuator assembly 116 can include a second engagement assembly configured to engage the article 100. The second engagement assembly can include third and fourth engagement members 123a, 123b that engage the article 100. The actuator assembly 116 can include third and fourth actuators 144a, 144b configured to move the third and fourth engagement members 123a, 123b, respectively. The third and fourth actuators 144a, 144b can move the third and fourth engagement members 123a, 123b in the lateral direction A. The third and fourth actuators 144a, 144b can be linear actuators or pistons. In other examples, the third and fourth actuators 144a, 144b are pneumatic, rotary, piezoelectric, magnetic, or hydraulic cylinder actuators. The controller can send a signal to at least one of the third and fourth actuators 144a, 144b. At least one of the third and fourth actuators 144a, 144b can move at least one of the third and fourth engagement members 123a, 123b in response to receiving an actuation signal.

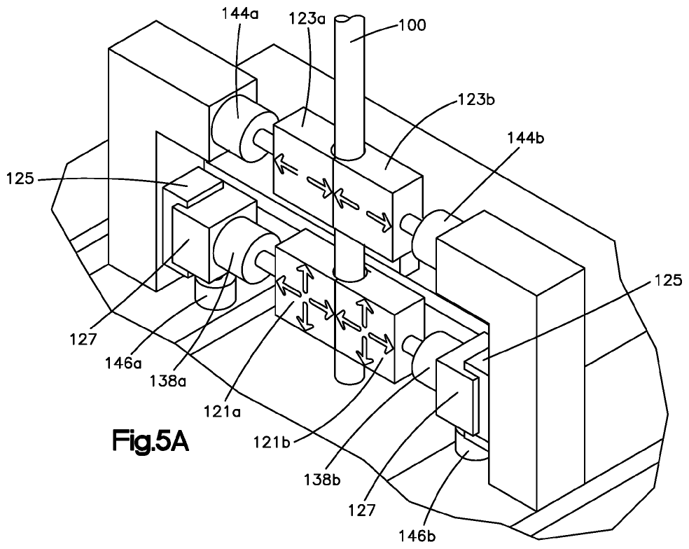

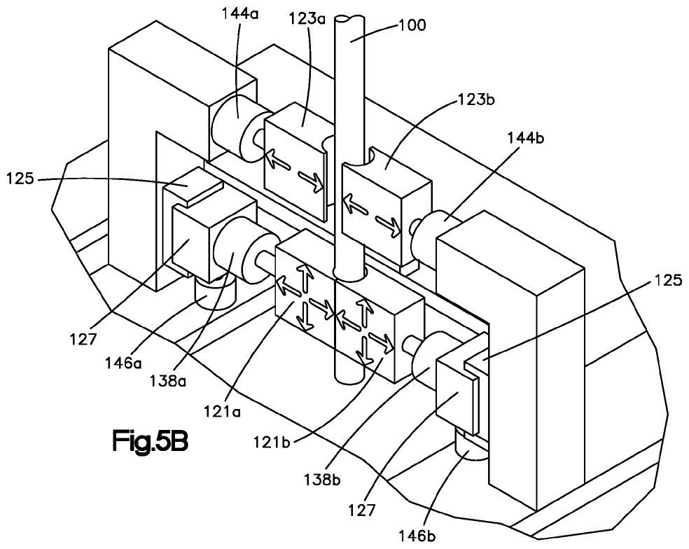

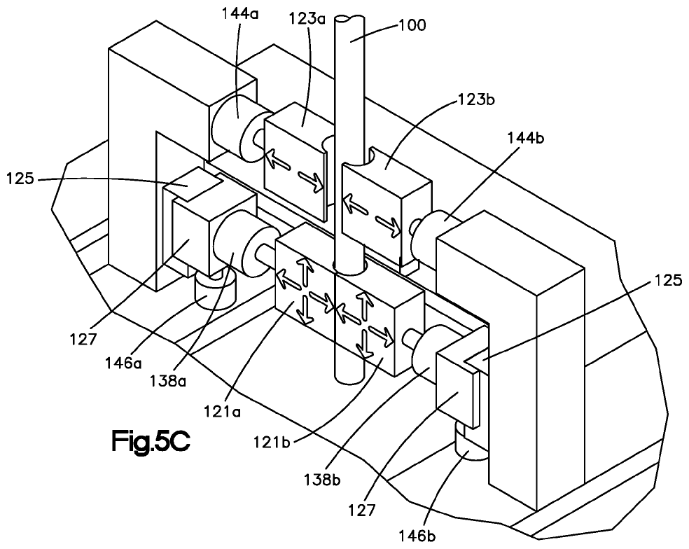

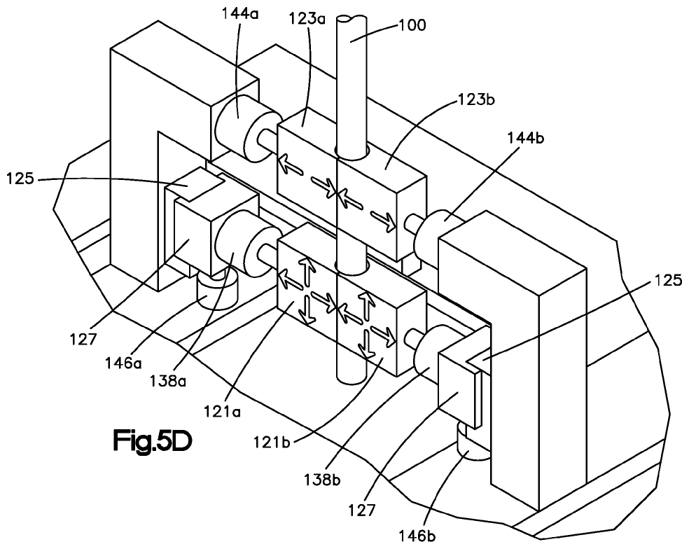

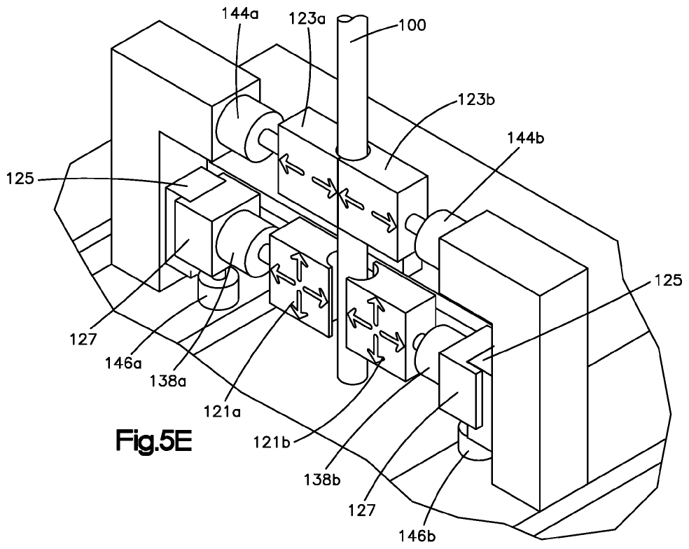

Referring to FIG. 5A, the first and second actuators 138a, 138b can be coupled to respective actuator blocks 127. The first and second actuators 138a, 138b can be fixed to the respective actuators blocks 127 in the longitudinal direction L. The actuator blocks 127 can be configured to engage the respective guide features 125 on the support arms 136. One of the guide feature 125 and the actuator block 127 can include a groove configured to receive a protrusion on the other of the guide feature 125 and the actuator block 127. The actuator block 127 can be movable relative to the guide feature 125 in the longitudinal direction L.

The actuation assembly 116 can include fifth and sixth actuators 146a, 146b configured to move respective actuator blocks 127 in the longitudinal direction L. The fifth and sixth actuators 146a, 146b can be linear actuators or pistons. In other examples, the fifth and sixth actuators 146a, 146b are pneumatic, rotary, piezoelectric, magnetic, or hydraulic cylinder actuators. The fifth and sixth actuators 146a, 146b can be coupled to respective spans 128. The fifth and sixth actuators 146a, 146b can each be fixed relative to the span 128. The fifth and sixth actuators 146a, 146b can each be positioned between one of the spans 128 and the actuator blocks 127 in the longitudinal direction L. The controller can send a signal to at least one of the fifth and sixth actuators 146a, 146b. At least one of the fifth and sixth actuators 146a, 146b can move at least one of the actuator blocks 127 in response to receiving an actuation signal.

The third and fourth actuators 144a, 144b can move the third and fourth engagement members 123a, 123b from an engaged configuration (FIG. 5A) to a disengaged configuration (FIG. 5B). The third and fourth engagement members 123a, 123b can be engaged with the article 100 in the engaged configuration. The third and fourth actuators 144a, 144b can move the third and fourth engagement members 123a, 123 in the lateral direction A between the engaged configuration and the disengaged configuration. The third and fourth engagement members 123a, 123b can move toward each other as the third and fourth engagement members 123a, 123b move from the disengaged configuration to the engaged configuration.

The third and fourth engagement members 123a, 123b can be disengaged from the article 100 in the disengaged configuration. The article 100 can be moveable along the longitudinal axis L relative to the third and fourth engagement members 123a, 123b when the third and fourth engagement members 123a, 123b are in the disengaged configuration. The article 100 can be fixed along the longitudinal axis L relative to the third and fourth engagement members 123a, 123b when the third and fourth engagement members 123a, 123b are in the engaged configuration.

The fifth and sixth actuators 146a, 146b can move the first and second engagement members 121a, 121b relative to the third and fourth engagement members 123a, 123b from a first position (FIG. 5B) to a second position (FIG. 5C) when the third and fourth engagement members 123a, 123b are in the disengaged configuration. The first and second engagement members 121a, 121b can be closer to the reservoir in the first position than in the second position. The fifth and sixth actuators 146a, 146b can apply a force to the respective actuator blocks 127 to move the actuator block 127 relative to the guide feature 125 from a first actuator block position (FIG. 5B) to a second actuator block position (FIG. 5C). The first and second actuators 138a, 138b, and the first and second engagement members 121a, 121b can move relative to the article 100 as the fifth and sixth actuators 146a, 146b move the actuator blocks 127 relative to the guide features 125. The first and second engagement members 121a, 121b can move in a first direction away from the reservoir as the actuator blocks 127 move from the first actuator block position to the second actuator block position. The first and second engagement members 121a, 121b can be fixed relative to the article 100 in the longitudinal direction L when the first and second engagement members 121a, 121b are engaged with the article 100. Therefore, the article 100 can move in the first direction as the first and second engagement members 121a, 121b move in the first direction. The fifth and sixth actuators 146a, 146b can move the actuator blocks 127 a selected distance in the first direction. The selected distance can be about 1-75 microns, about 1-25 microns, about 25-50 microns, about 50-75 microns, or more than about 75 microns.

The third and fourth actuators 144a, 144b can move the third and fourth engagement members 123a, 123b from the disengaged configuration (FIG. 5C) to the engaged configuration (FIG. 5D) when the first and second engagement members 121a, 121b are in the second position. Therefore, the first, second, third, and fourth engagement members 121a, 121b, 123a, 123b can be engaged with the article 100 simultaneously.

The first and second actuators 138a, 138b can move the first and second engagement members 121a, 121b from an engaged configuration (FIG. 5D) to a disengaged configuration (FIG. 5E). The first and second engagement members 121a, 121b can engage the article 100 in the engaged configuration. The first and second actuators 138a, 138b can move the first and second engagement members 121a, 121b away from each other as the first and second engagement members 121a, 121b move to the disengaged configuration. The first and second engagement members 121a, 121b can move from the engaged configuration to the disengaged configuration when the third and fourth engagement members 123a, 123b are in the engaged configuration. The third and fourth engagement members 123a, 123b in the engaged configuration can prevent movement of the article 100 in the longitudinal direction L.

The first and second engagement members 121a, 121b can be movable relative to the article 100 in a second direction opposite the first direction when the first and second engagement members 121a, 121b are in the disengaged configuration. The fifth and sixth actuators 146a, 146b can move the first and second engagement members 121a, 121b in the second direction from the second position (FIG. 5E) to the first position (FIG. 5F) when the first and second engagement members 121a, 121b are in the disengaged configuration. For example, the fifth and sixth actuators 146a, 146b can move the actuator blocks 127 from the second actuator block position (FIG. 5E) to the first actuator block position (FIG. 5F). The first and second engagement members 121a, 121b can be movable relative to the third and fourth engagement members 123a, 123b when the first and second engagement members 121a, 121b are in the disengaged configuration. The first and second engagement members 121a, 121b can move a select distance from the second position to the first position. The selected distance can be about 1-75 microns, about 1-25 microns, about 25-50 microns, about 50-75 microns, or more than about 75 microns.

The first and second engagement members 121a, 121b can move from the disengaged configuration (FIG. 5F) to the engaged configuration (FIG. 5A) when the first and second engagement members 121a, 121b are in the first position. In some examples, the printer 112 is activated to cure the compound or resin to solidify an additional segment of the article 100 when the first and second engagement members are in the first position. In other examples, the printer 112 is activated as the first and second engagement members 121a, 121b are in the second position. The process can then be repeated to prepare an article 100 having any desired length.

Referring back to FIG. 3, the printer 112 can include a guide 148 for the article 100. The article 100 can engage the guide 148 as the actuator assembly 116 moves the article 100. The guide 148 can include a guidewheel rotatably coupled to a support arm. The guidewheel can be rotatable relative to the support arm as the article 100 moves relative to the printer 112. The guide 148 can be a track adapted to receive the article 100.

Referring now to FIG. 4, a wash station 150 can be configured to wash the article 100. The wash station can be adapted to wash the article 100 with a liquid. The wash station 150 can be adapted to wash the article 100 with a detergent. The wash station 150 can be adapted to remove any uncured compound from the article 100. The wash station 150 can include a housing 151 and the article 100 can pass through at least a portion of the housing 151.

A drying station 152 can be adapted to dry the article 100. The drying station 152 can be adapted to dry any liquid on the article 100 after washing. The drying station 152 can include a housing 153 and the article 100 can pass through at least a portion of the housing 153. In some embodiments, the washing station 150 and drying station 152 can be combined into a single station. Some examples of combined wash and curing stations contemplated for use are the Wash & Cure manufactured by Anycubic of Shenzhen, Guangdong, China and the Mercury X manufactured by Elegoo Inc. of Shenzhen, Guangdong, China.

A curing station 154 can be adapted to further cure the article 100. The curing station 154 can include a housing 155 and the article 100 can pass through at least a portion of the housing 155. The curing station 154 can be an ultraviolet (“UV”) curing station. The curing station 154 can emit UV light. The printer 112 can cure the compound from a first state to a second state. The first state can be a liquid state or a semi-liquid state. The compound can have a high viscosity in a semi-liquid state. The compound can be cured into the article 100 as the printer 112 cures the compound from the first state to the second state. The article 100 can be a solid in the second state but the compound may not be fully cured in the second state. The curing station can fully cure the compound. UV curing can include exposing the partially cured compound or polymer to light. The light can have a wavelength of about 100 nm to about 1,000 nm, about 200 nm to about 800 nm, about 300 nm to about 600 nm, about 400 nm to about 500 nm, or about 405 nm. The light can be a light emitting diode (“LED”). UV curing can include exposing the polymer to UV light for a selected time period. The selected time period can be less than about 1 minute, about 1 minute, greater than about 1 minute, greater than about 5 minutes, greater than about 10 minutes, less than about 10 minutes, or less than about 5 minutes.

The article 100 can be collected by a spool 156. The article 100 can be wound about the spool 156. The spool 156 can receive an article 100 of infinite length.

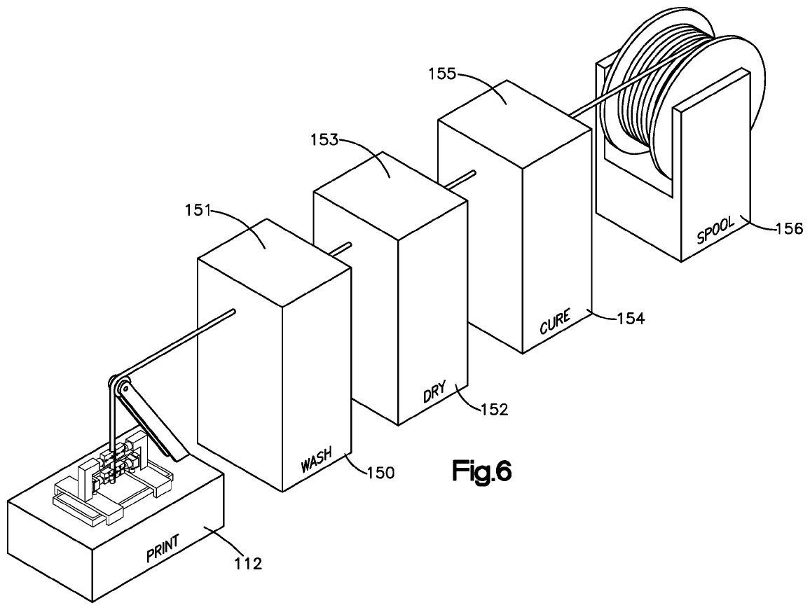

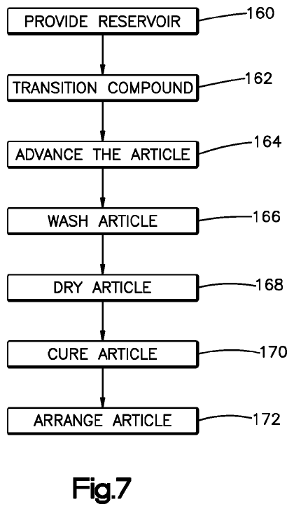

Referring to FIG. 7, a method of manufacturing the article 100 is shown. The method can include printing the article 100 with the printer 112. The method can exclude extruding. The method can exclude injection molding. The method can include a step 160 of providing a reservoir of compound. The compound in the reservoir 118 can have a depth of approximately 1 micron to approximately 75 microns. The depth of the compound can be equal to the height of the reservoir 118. Step 160 can include providing a reservoir of polymer. Step 160 can include providing a reservoir of polymer, photopolymer, or resin at a selected depth.

The method can include providing a starting element. The starting element can be a filament to which the compound can be cured, sintered, or otherwise adhered. The starting element can be a sacrificial element. The starting element can be a sacrificial material to which the compound can be coupled to begin creating the article 100. The starting element can be a section of a previously created article 100. The method can include engaging the starting element with the actuator assembly 116. For example, the first and second engagement members 121a, 121b can engage the starting element. The method can include positioning the starting element such that at least a portion of the starting element is within the reservoir. The starting element can be moved into contact with the compound in the reservoir 118.

The method can include a step 162 of transitioning the compound from the first state to the second state. The step 162 can include curing the compound to form a cured compound. The step 162 can include sintering the compound. Transitioning can include transitioning the compound with the printer 112. The curing step 162 can include exposing the compound to light. The curing step 162 can include exposing the compound to ultraviolet light. Sintering can include exposing the compound to an elevated temperature for a selected time period. The elevated temperature can be at least 50 degrees Celsius, at least 75 degrees Celsius, at least 100 degrees Celsius, at least 200 degrees Celsius, at least 300 degrees Celsius, at least 400 degrees Celsius, at least 500 degrees Celsius, or at least 750 degrees Celsius. The selected time period can be at least 1 second, at least 10 seconds, at least 30 seconds, at least 1 minute, at least 5 minutes, at least 10 minutes, or at least 20 minutes. Sintering can include exposing the compound to an elevated pressure for the selected time period. The elevated pressure can be at least 1 atmosphere (ATM), at least 100 ATM, at least 1,000 ATM, at least 5,000 ATM, or at least 10,000 ATM. Step 162 can include curing at least half the depth of the compound. Step 162 can include curing approximately 1-75 microns of the compound. Step 162 can include curing the compound while the compound is in contact with the non-stick sheet. Step 162 can include curing the compound while the compound is in contact with the non-stick sheet such that the cured compound is fixed to the non-stick sheet.

The method can include a step 164 of advancing the article 100. Step 164 can include detaching the article 100 from the non-stick sheet. Step 164 can include advancing the article 100 with the actuation assembly 116. Step 164 can include engaging the article 100 with the first and second engagement members 121a, 121b. Step 164 can include disengaging the third and fourth engagement members 123a, 123b from the article 100. Step 164 can include advancing the article 100 by moving the first and second engagement members 121a, 121b in the first direction away from the reservoir 118. At least one pair of the first and second engagement members 121a, 121b and the third and fourth engagement members 123a, 123b can be engaged with the article 100 throughout step 164.

Step 164 can include engaging the article 100 with the third and fourth engagement members 123a, 123b. The third and fourth engagement members 123a, 123b can engage the article 100 after the first and second engagement members 121a, 121b advance the article away from the reservoir 118. Engaging the article 100 with the first, second, third, and fourth engagement members 121a, 121b 123a, 123b can include moving each of the first, second, third, and fourth engagement members 121a, 121b 123a, 123b toward the article 100. Step 164 can include sequentially engaging the article 100 with the first and second engagement members 121a, 121b and then the third and fourth engagement members 123a, 123b. Step 164 can include sequentially disengaging the first and second engagement members 121a, 121b and then the third and fourth engagement members 123a, 123b from the article 100. Step 164 can include disengaging the first and second engagement members 121a, 121b from the article 100 while the third and fourth engagement members 123a, 123b are engaged with the article 100. Step 164 can include disengaging the third and fourth engagement members 123a, 123b from the article 100 while the first and second engagement members 121a, 121b are engaged with the article.

Step 164 can include moving the first and second engagement members 121a, 121b relative to the third and fourth engagement members 123a, 123b. Step 164 can include moving the first and second engagement members 121a, 121b relative to the third and fourth engagement members 123a, 123b while the first and second engagement members 121a, 121b are in the disengaged configuration. Step 164 can include moving the first and second engagement members 121a, 121b relative to the third and fourth engagement members 123a, 123b while the article 100 is fixed relative to the third and fourth engagement members 123a, 123b in the first direction. Step 164 can include moving the first and second engagement members 121a, 121b relative to the third and fourth engagement members 123a, 123b in the longitudinal direction L. Moving the first and second engagement members 121a, 121b in the second direction can include moving the first and second engagement members 121a, 121b toward the reservoir 118. Step 164 can include reengaging the article 100 with the first and second engagement members 121a, 121b after moving the first and second engagement members 121a, 121b toward the reservoir 118. Step 164 can include disengaging the third and fourth engagement members 123a, 123b from the article 100 after engaging the article 100 with the first and second engagement members 121a, 121b. Step 164 can include moving the first and second engagement members 121a, 121b relative to the third and fourth engagement members 123a, 123b after disengaging the third and fourth engagement members 123a, 123b from the article 100. Step 164 can include moving the first and second engagement members 121a, 121b relative to the third and fourth engagement members 123a, 123b in the longitudinal direction L after disengaging the third and fourth engagement members 123a, 123b from the article 100. Moving the first and second engagement members 121a, 121b relative to the third and fourth engagement members 123a, 123b can include moving the article 100 relative to the third and fourth engagement members 123a, 123b. Moving the first and second engagement members 121a, 121b relative to the third and fourth engagement members 123a, 123b can include moving the first and second engagement members 121a, 121b away from the reservoir.

Step 164 can include reengaging the cured compound with the third and fourth engagement members 123a, 123b after the first and second engagement members 121a, 121b move relative to the third and fourth engagement members 123a, 123b. Reengaging the article 100 with the third and fourth engagement members 123a, 123b can include reengaging the article 100 with the third and fourth engagement members 123a, 123b while the first and second engagement members 121a, 121b are engaged with the article 100 article 100.

The method can include printing a plurality of segments. Steps 160, 162, 164 can create one segment of the plurality of segments. The steps 160, 162, 164 can be repeated for any number of iterations to create a plurality of segments, thereby creating an article 100 of any desired length. The method can include curing a first segment having a longitudinal length of any one of approximately 1-75 microns, and any integer or fraction within this range. The first cured segment can then be advanced approximately 1-75 microns, and any integer or faction within this range. A second cured segment can be cured to the first cured segment. This process can be repeated, in theory, a finite or infinite number of times to form a dielectric, such as a dielectric waveguide or a cable dielectric or a lattice dielectric with a longitudinal length of any one or more of at least approximately 2.54 centimeters, at least approximately 5 centimeters, at least approximately 7.6 centimeters, at least approximately 10 centimeters, at least approximately 12 centimeters, at least approximately 15 centimeters, at least approximately 17 centimeters, at least approximately 20 centimeters, at least approximately 22 centimeters, at least approximately 25 centimeters, at least approximately 28 centimeters, at least approximately 30 centimeters, at least approximately 1 meter, at least approximately 2 meters, at least approximately 3 meters and at least 3 meters. As described herein, continuous can mean that a cured segment of polymer or resin or photopolymer can be added to an already cured segment of cured polymer or resin or photopolymer and this process can be repeated, in theory, until any desired unit length of dielectric material is created.

The first segment can have a segment height in the longitudinal direction L. Step 164 can include advancing the cured compound by a distance less than the segment height. Step 164 can include advancing the cured compound by a distance of at least half the segment height. Step 164 can include advancing the cured compound by a distance equal to the segment height.

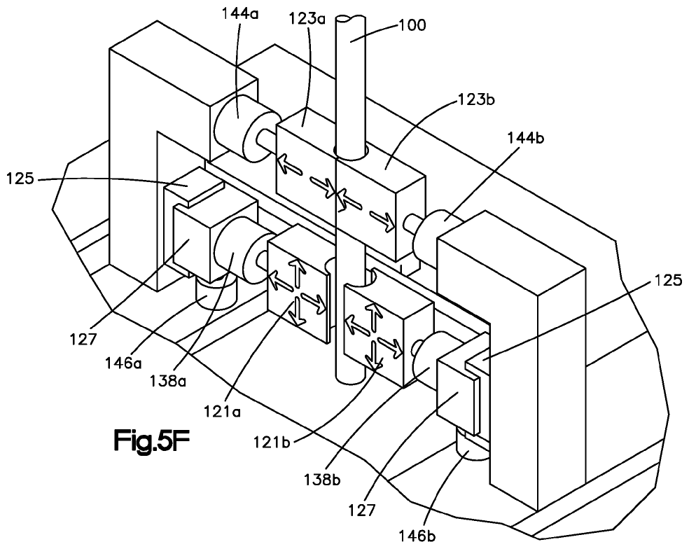

The method can include a step 166 of washing the article 100. Step 166 can include removing any uncured compound from the article 100. The method can include a step 168 of drying the article 100. The method can include a step 170 of curing the article 100 by exposing the compound to ultraviolet light. The method can include a step 172 of arranging the article. Step 172 can include spooling the article 100 on a spool 156 (see FIG. 6). Steps 160, 162, and 164 can be performed without a monolithical support member or a sacrificial support member. Two or more of steps 164, 166, 168, 170, and 172 can be performed simultaneously. For example, two or more of steps 164, 166, 168, 170, and 172 can be performed simultaneously on different portions of the article 100 along its length.

In partial summary, an article 100 can include a plurality of segments or segments, such as cured segments or cured layers, that can each be stacked parallel to one another. A plurality of cured segments can each be stacked sequentially along a common longitudinal axis. A plurality of cured segments can each be formed without the use of a cavity mold. An article 100 can include a plurality of cured segments or layers that can be individually stacked sequentially along a common longitudinal axis. Immediately adjacent ones of the plurality of cured segments or layers can be configured to not envelop or wrap around one another. The article 100 can be entirely hollow along one or more of its length, width or height, can be entirely solid along one or more of its length, width or height, or can have both solid portions and hollow portions along one or more of its length, width or height. For example, the article can take the shape or form of the dielectric waveguides disclosed in U.S. Pat. No. 11,031,666, hereby incorporated by reference in its entirety.

Each of the plurality of cured segments or layers can take the shape of a sheet having two opposed broad stretches or surface. Immediately adjacent ones of the plurality of cured segments or layers can be cured or adhered together. One of the two opposed broad stretches or surfaces of one of the plurality of cured segments or layers can face one of the two opposed broad stretches or surfaces of an immediately adjacent one of the plurality of cured segments or layers. The plurality of cured segments or layers can each be made or can each contain a photopolymer. All of the cured segments or layers can be made entirely from a photopolymer. The article 100 can be made without an extrusion die.

As disclosed above, a waveguide for electromagnetic radiation may be formed by additive manufacturing. The waveguide may be a metal waveguide, a dielectric waveguide, or use a combination of metal and dielectric materials. The waveguide is a longitudinally extended structure formed by successive addition of thin segments of materials arranged along the longitudinal. For example, each thin layer or segment may have a thickness of between approximately 10 microns to 100 microns.

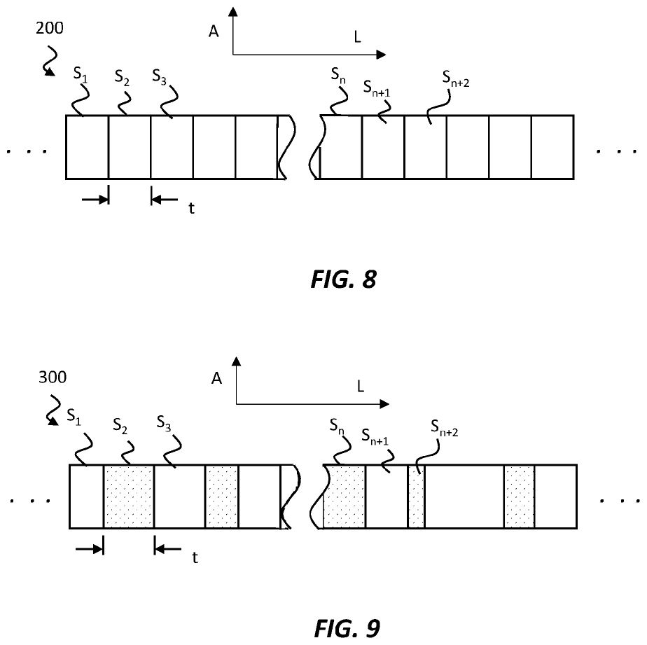

FIG. 8 shows a simplified schematic of such a dielectric waveguide 200. The waveguide is composed of many successive layers or segments, denoted as S with a subscript, of material, such as a dielectric material formed from a photocurable polymer. Each layer or segment of a plurality of segments forming the waveguide, S, may be formed from a material having nominally identical properties and each layer may have a uniform thickness, t. Even though each segment is nominally identical, and each segment is nominally longitudinally invariant along its thickness, there may be some longitudinal variation within each segment, S. For example, each segment may be somewhat barrel or hour glass shaped so that the outer diameter of the waveguide varies with a periodicity given by the segment thickness t. This difference in the segment along the longitudinal direction may create a small, reflected wave at each segment from a wave propagating down the waveguide 200 in the longitudinal direction. These reflections may also be guided down the waveguide, but in an opposite direction from the propagation direction of the original wave. While the individual reflections may be very small, if the reflections add coherently, they may result in all or most of the propagating wave being back reflected. Such behavior allows the waveguide to act as a narrow band filter back reflecting electromagnetic radiation propagating at a specific wavelength matching the periodicity of the segments, t.

If such filtering is not desired the thickness of the successive segments, S, may be varied in a random manner as shown in FIG. 9. The thickness may be chosen in a random or pseudo-random manner and may be in a range of approximately 10 microns to 100 microns. Since the segment are arranged in an aperiodic manner any reflected waves will not coherently add, and a reflected level of power may remain low.

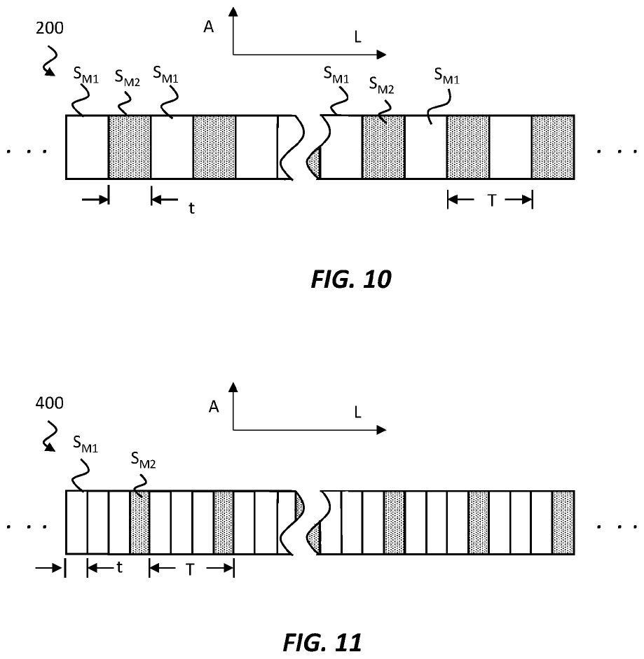

To increase the reflected power at each segment interface, the plurality of segments may be of at least two types having different effective dielectric constants or cross-sectional shapes. For example, the segments may be composed of materials having different dielectric properties. FIG. 10 shows a simplified schematic illustration of such a waveguide 300. In this waveguide every other segment in the waveguide may be made of a first material, M1, and the alternate segments may be made of a second material, M2, having different dielectric properties. The segments composed of the first material may be denoted as first segments S_{M1} and the segments composed of the second material may be denoted as second segments S_{M2}. For example, if the segments are formed from a polymer, the polymer forming the first segments S_{M1} and the segments composed of the second material may be denoted as second segments S_{M1} may have more cross-linkage than the polymer forming the second segments S_{M1} and the segments composed of the second material may be denoted as second segments S_{M2}. Alternatively, the polymers in the first and second segments S_{M1} and S_{M2} may have different compositions obtained by changing the composition of the material in the reservoir. A further alternative may be to have first segments have a different cross-sectional shape or area as compared to second segments. The thickness of the first segments S_{M1} may also be different from the thickness of the second segments S_{M2}. The plurality of first segments and the plurality of second segments may form a repeating pattern of interspersed first segments and second segments.

For example, assume that all segments have an equal thickness of 50 microns. The thickness of the periodic structure, T, is then twice this value or 100 microns. If we assume an effective dielectric constant of the waveguide of 3 we obtain a free space wavelength of 300 microns, which corresponds to a frequency of 1 THz. Radiation at this frequency would be strongly reflected by the waveguide shown in FIG. 10.

The spacing between successive second segments S_{M2} separated by first segments S_{M1} not be a single segment of the first segment S_{M1}. FIG. 11 shows a waveguide 400 with three successive first segments S_{M1} followed by a second segment S_{M2} in a repeating pattern. The thickness of the periodic structure T is not limited by the thickness of a segment t, since many segments can be in the repeating pattern. It should be appreciated that the example of 3 segments of the first segment between each successive second segment is exemplary only, there may be as many first segments between successive second segments as desired. Also, the thickness of each first segment may be different or vary in a random or pseudo-random manner to avoid coherent back reflections from interfaces between successive junctions of the first segments S_{M1}. Moreover, there need not be a single second segment S_{M2}, but multiple second segments may be interspersed with multiple first segments S_{M1}.

Using the same segment thickness of 50 microns we used in the previous example, the periodic structure thickness is now 200 microns. Again, assuming an effective dielectric constant of the waveguide of 3, this periodicity corresponds to a frequency of 500 GHz. Radiation at this frequency would be strongly reflected by the waveguide shown in FIG. 11.

Reflectors at longer wavelengths and lower frequencies, such as frequencies in a range between approximately 10 to 200 GHz may be fabricated by using a plurality of first segments followed by a plurality of second segments. Again, assuming an effective waveguide dielectric constant of 3, a waveguide periodicity of 500 microns would reflect radiation at 200 GHz and a waveguide periodicity of 10 mm would reflect 10 GHz radiation.

Reflective and transmissive filters having a wide range of properties may be made by appropriate selection of the segment lengths and effective dielectric constant or cross-sectional shape modulation between segments. For example, first and second segments with two different periodicities may be made that reflect two radiation frequencies. Such an arrangement may form a reflective filter that reflects a first and a second frequency of electromagnetic radiation and passes a third frequency of electromagnetic radiation, the third frequency being a higher frequency than the first frequency and a lower frequency than the second frequency. The segments lengths can vary to shape or apodize filtering characteristics of the waveguide. The segments may have more than two different effective dielectric constants.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention. Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

1. A method of fabricating a dielectric waveguide, the method comprising steps of:
a. curing a polymer in a reservoir from a first state to a second state;
b. incrementally advancing the cured polymer approximately an incremental distance away from the reservoir; and
c. repeating steps a) to b).

2. (canceled)

3. The method of claim 1, wherein the incremental distance is within a range of approximately 1 micron to approximately 75 microns.

4. The method of claim 1, wherein curing the polymer from the first state to the second state includes curing the polymer from a liquid state to a solid state.

5. (canceled)

6. (canceled)

7. (canceled)

8. The method of claim 1, wherein the polymer is a photopolymer resin.

9. The method of claim 1, wherein the curing step includes exposing the polymer to a light source.

10. (canceled)

11. (canceled)

12. The method of claim 1, wherein the curing step includes curing at least half the depth of the polymer.

13. The method of claim 1, wherein the curing step includes curing approximately 1 micron to approximately 75 microns of the polymer to form a cured polymer.

14. The method of claim 1, wherein the curing step includes curing the polymer while the polymer is in contact with a non-stick sheet.

15. The method of claim 14, wherein the reservoir includes a non-stick sheet and the curing step includes curing the polymer while the polymer is in contact with the non-stick sheet.

16. (canceled)

17. (canceled)

18. (canceled)

19. The method of claim 14, wherein the non-stick sheet comprises polytetrafluoroethylene.

20. (canceled)

21. The method of claim 1, wherein the polymer comprises an electrically conductive material.

22. The method of claim 1, wherein the curing step includes curing the polymer with a printer.

23. (canceled)

24. The method of claim 22, wherein the printer includes an actuator assembly and the method includes engaging the cured polymer with the actuator assembly.

25. (canceled)

26. The method of claim 24, wherein the actuator assembly includes a first engagement assembly and a second engagement assembly, wherein the method includes engaging the cured polymer with the first and second engagement assemblies.

27. The method of claim 26, wherein at least one of the first and second engagement assemblies are engaged with the cured polymer during the curing step.

28. (canceled)

29. The method of claim 27, wherein engaging the cured polymer with the first and the second engagement assemblies includes moving each of the first and second engagement assemblies relative to the cured polymer.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. The method of claim 26, further comprising engaging a sacrificial element with the first engagement assembly and the second engagement assembly.

46. The method of claim 45, further comprising moving the sacrificial element toward the reservoir such that at least a portion of the sacrificial element is within the reservoir.

47. The method of claim 46, wherein the curing step includes curing the polymer such that the cured polymer is coupled to the sacrificial element.

48. (canceled)

49. (canceled)

50. The method of claim 1, further comprising engaging the polymer with a starter filament prior to the curing step.

51. (canceled)

52. (canceled)

53. (canceled)

54. (canceled)

55. (canceled)

56. (canceled)

57. (canceled)

58. (canceled)

59. The method of claim 1, wherein the cured polymer is not extruded.

60. The method of claim 1, wherein the dielectric waveguide is adapted to allow an electromagnetic signal to pass from a first end of the dielectric waveguide to a second end of the dielectric waveguide.

61-112. (canceled)
